(19) United States
(12) Patent Application Publication
(10) Pub. No.: US 2004/0059901 A1
(43) Pub. Date: Mar. 25, 2004

(54) Removable configuration module for storage of component configuration data

(76) Inventors: Joel P. Miller, Vacaville, CA (US); Brian D. Osterhout, Oakdale, CA (US)

Correspondence Address: Robert C. Kowert, P.O. Box 398, Austin, TX, 78767, US

(21) Appl. No.: 10/254,755

(22) Filed: Sep. 25, 2002

(51) Int. Cl. G06F 15/16; G06F 9/00

(52) U.S. Cl. 713/1; 709/227

(57) ABSTRACT

A storage network may include one or more hosts connected to one or more storage systems. The storage network may be a Fibre Channel switched fabric and may include many different components such as Field Replaceable Units (FRUs). A component, such as a disk drive in a disk storage array, may be coupled to the storage network. A removable configuration module comprising configuration data for configuring the component for access via the storage network may be coupled to the component. The configuration data may include a unique component identifier, logical and physical layout data, component status indicators, etc. The unique component identifier may include a World Wide Name (WWN) and a media access control (MAC) address. The removable configuration module may be decoupled from the component and coupled to a different component. The different component may be readily accessible by the storage network.

### BACKGROUND

1. Field of the Invention

This invention relates to computer systems, and more particularly to the configuration of components in computer systems.

2. Description of the Related Art

With the growing deployment of computer systems and software, applications often operate in distributed, heterogeneous environments. Processing in a complex application may be partitioned across network segments, CPU clusters and storage locations. Furthermore, computer systems in distributed, heterogeneous environments may include many different components that impact overall availability of the systems. The increasing complexity of software and the increasing degree of dependence on computer systems have imposed the adoption of various techniques to minimize system downtime.

One of the most cost-effective techniques, and also a major motivating factor behind the evolution of modular construction of computer systems, is the use of modular components. Within a computer system, a modular component may be the smallest unit that can be identified with a specification or by a supplier, distributed and redistributed, and added for expansion or replaced if faulty. A modular component may be any unit designed to be added or replaced at the location where the unit is operating, e.g. a field replaceable unit (FRU). Modular components are often used for mass produced products because a part may be easily added or replaced without returning the entire product to another facility. Some modular components may be replaced or added by a user. Replacement or addition of other modular components may require trained service personnel.

Sometimes modular components fail to operate as expected. A defective component may be found by standard troubleshooting procedures, removed, and either discarded or shipped to a repair facility. A new component may be installed in place of the defective component. Numerous problems may arise when replacing the defective component with the new component. For example, configuration information used to configure a defective component may be different for a new component. Various system parameters associated with the new component may be needed to configure the new component once the new component is installed. The system parameters may be unique identifiers, status indicators, or other parameters needed by the computer system to utilize the component. Configuration information is often copied from an alternate location or re-entered by a user to configure a new component for use by a computer system. The system parameters may be programmed into the defective component's firmware. Thus, the system parameters, as stored on the defective component, may be non-transferable. As a result, if the computer system relies on a previously created identifier used to establish communication links to the component, links to the new component may need to be recreated since the system parameters are non-transferable. In order to configure the new component for use with the computer system, the configuration information for the new component may need to be re-entered by a user and/or copied to the new component.

Some system parameters may be stored on a location external to a component. For example, other system parameters may be stored in another component external to the defective component. Although the system parameters may be transferable, certain conditions may increase the opportunity for errors when replacing the defective component, especially in complex computer systems. For example, a storage device array may include numerous storage devices coupled to an array controller. The system parameters may be stored in memory on the array controller. Multiple failures may occur with the storage devices in the storage device array. Thus, failed storage device components may be replaced with new storage device components. When replacing each failed storage device, the system parameters may be transferred from the array controller to the new storage devices.

As these examples show, making configuration changes, especially for multiple failures in complex systems, may be unduly complicated. It is desirable to be able to replace components without having to perform complex component reconfiguration.

### SUMMARY

A storage network may include one or more hosts connected to one or more storage systems. The storage network may be a Fibre Channel switched fabric and may include many different components such as Field Replaceable Units (FRUs). A component, such as a disk drive in a disk storage array, may be coupled to the storage network. A removable configuration module comprising configuration data for configuring the component for access via the storage network may be coupled to the component. The configuration data may include a unique component identifier, logical and physical layout data, component status indicators, etc. The unique component identifier may include a World Wide Name (WWN) and media access control (MAC) address. The removable configuration module may be decoupled from the component and coupled to a different component. The different component may be accessed via the storage network as the first component.

The removable configuration module may be a card including at least one non-volatile memory device. The card may be a compact flash card or a smart card which is similar to a plastic credit card with at least one memory device. A component chassis may be coupled to a receptacle and the receptacle may be configured to couple to the removable configuration module to access the configuration data. The removable configuration module may be inserted into the receptacle via pin connectors to access the configuration data.

A component interface may be configured to access the configuration data from the removable configuration module and to provide the configuration data to an application executing on a host. The application may be configured to configure the component for access via the storage network. In one embodiment, the application may receive the configuration data from the removable configuration module and create a unique system identifier to access the component via the network. The removable configuration module may be removed from the component and coupled to a different component. The different component may be accessed by the application as the first component.

### BRIEF DESCRIPTION OF THE DRAWINGS

FIG. 1 is an example of a storage network, according to one embodiment;

FIG. 2 illustrates a storage system including a component coupled to a removable configuration module that stores configuration data for the component, according to one embodiment;

FIG. 3 shows a component that includes a receptacle for inserting a removable configuration module, according to one embodiment;

FIG. 4 shows a method for accessing configuration data stored on a removable configuration module coupled to a component, according to one embodiment; and

FIG. 5 shows a method for accessing configuration data stored on a removable configuration module coupled to a replacement component, according to one embodiment.

While the invention is described herein by way of example for several embodiments and illustrative drawings, those skilled in the art will recognize the invention is not limited to the embodiments or drawings described. It should be understood that the drawings and detailed description thereto are not intended to limit the invention to the particular form disclosed, but on the contrary, the intention is to cover all modifications, equivalents and alternatives failing within the spirit and scope of the invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

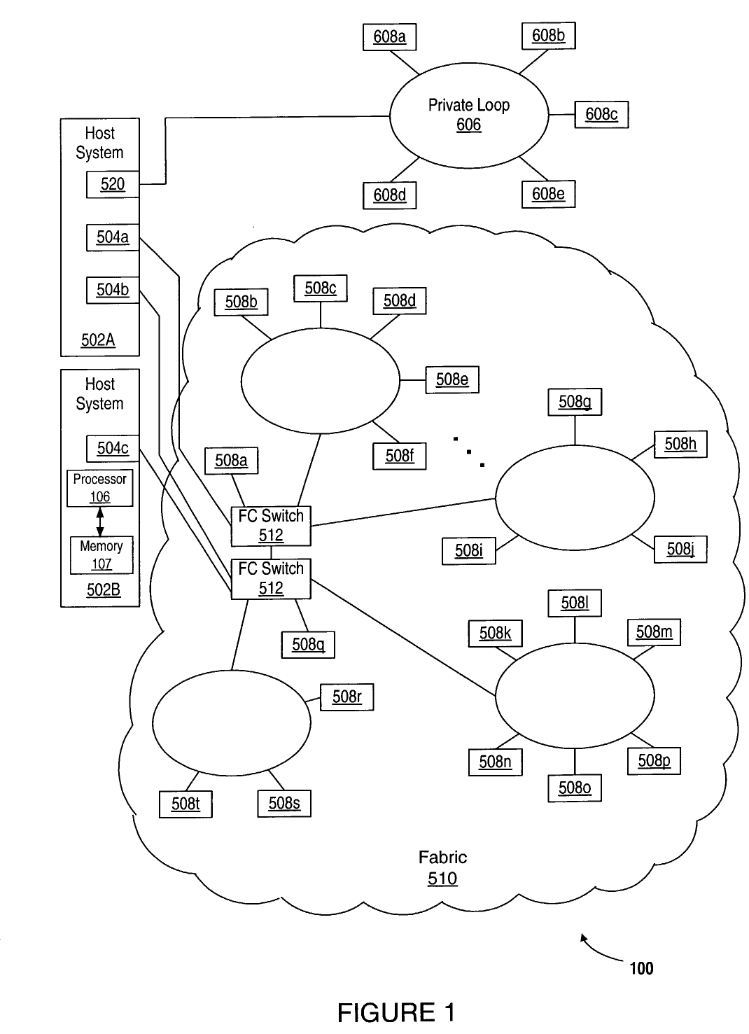

FIG. 1 illustrates an exemplary embodiment of storage network 100 that includes a direct attached private loop 606 and a fabric 510. Storage network 100 may also include one or more hosts 502 connected to one or more storage systems 508 and 608. A host 502 may include memory 107, a central processing unit (CPU) or processor 106, and host adapters 504 and 520.

The storage network 100 may be configured in a variety of different ways and may include one or more direct attach devices, storage area networks (SANs), and/or network attach devices (NAS). Storage network 100 may include fibre channel technologies. The storage network 100 may not be limited to fibre channel technologies and architectures but may include various types of technologies. For example, some or all of the storage network 100 may be based on the InfiniBand™ architecture or Small Computer System Interface over IP (iSCSI). The storage network 100 may include various types of topologies (e.g., geometric arrangements of components in the network), protocols (e.g., rules and encoding specifications for sending data), and media (e.g., twisted-pair wire, coaxial cables, fiber optic cables, radio waves).

In some embodiments, a plurality of hosts may communicate with a plurality of storage systems via one or more connections. Host adapter 504 couples host system 502A to private loop 606 and adapters 504a and 504b couple host system 502A to fabric 510. Coupled to private loop 606 are one or more direct attach devices 608. Direct attach device(s) are considered local to host system 502A.

The host system 502B may be coupled to fabric 510 via host adapter 504c. Fabric 510 may include fibre channel switches 512 which are coupled to multiple fabric devices 508. Each fibre channel switch 512 may connect to various fibre channel topologies such as point-to-point fibre channel connections or fibre channel loops. Each switch 512 may also connect to one or more other fibre channel switches. The fabric devices 508 may be various storage devices such as storage systems, hard disk drives, optical drives, tape drives, etc.

Some embodiments of storage network 100 may not include the same hosts, components, or types of components shown in FIG. 1. Some hosts within storage network 100 may include other components such as application software, other CPUs, video monitors or other displays, track balls, mice, keyboards, printers, plotters, scanners, or other types of I/O devices for use by hosts within storage system 100. Host 502 may include memory 107 and CPU 106. Memory 107 may store program instructions accessed by CPU 106. Additionally, host 502 may also include an operating system and an input/output (I/O) interface to couple other components to the host 502. Host 502 may access other types of components. For example, storage network 100 may also include other types of components such as network adapters or other network devices. The number and types of hosts and components are for illustration purposes. The actual number and types of hosts and/or components in a storage network may vary.

One or more components coupled to storage network 100 may be modular components. Modular components may be any unit designed to be added or replaced at a location where the unit is operating. For example, a component may fail and the component may be removed and replaced with another component that operates as expected. A component may be added to a host to expand resources of the host. Field replaceable units (FRUs) are an example of modular components.

A component may be coupled to a removable configuration module that stores configuration data for the component. Note that the removable configuration module coupled to a component stores configuration data for the component but is not necessarily part of the primary function of the component. Some components may have other removable storage media that are part of the components primary function. CD-ROM drives, DVD drives, etc. are examples of components with a primary function of accessing data from a removable storage medium such as a CD or DVD. Disk drives in a fabric may perform a primary function of accessing data stored on a hard disk. The removable configuration module may be separate from storage media that are associated with the primary function of a component.

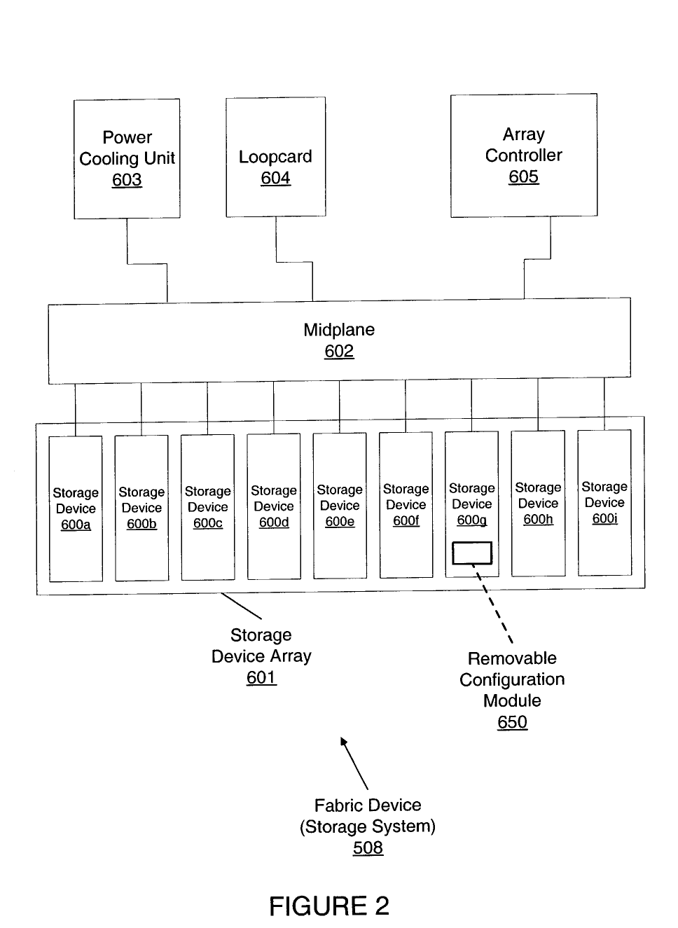

FIG. 2 shows an exemplary embodiment of a fabric device 508 that includes a component 600g coupled to a removable configuration module 650. Removable configuration module 650 may be removed (as indicated by the broken line) from the component 600g and coupled to a replacement component. The component 600g may then be replaced with the replacement component.

The fabric device 508 may be a storage system and may include many different components including a storage device array 601, storage devices 600a-600i, a power/cooling unit 603, a loopcard 604, a midplane 602 and an array controller 605. The number and type of components included in a particular embodiment may vary. Storage system 508 may be a redundant array of inexpensive disk (RAID) storage subsystem or other type of storage array. In some embodiments, multiple host computers may communicate with several storage systems 508 via host adapters, as shown in FIG. 1. In other embodiments, the storage system 508 may be a dense, compact system built on a midplane design. For example, each type of storage device 600 in a physical midplane design may include a front logic card for circuit functionality and a rear interface card for mechanical and electrical interface functions (e.g., no internal cables). Even while a host is operating, the physical midplane design may allow a specific storage device 600 to be installed or removed without affecting other storage devices in storage device array 601.

Included within storage system 508 is storage array 601 that includes a plurality of storage devices 600a-600i (collectively referred to as storage devices 600). Storage devices 600a-600i may be, for example, magnetic hard disk drives, optical drives, magneto-optical drives, tape drives, solid state storage, or other non-volatile memory. In one embodiment, storage devices 600 may be disk drives and storage array 601 may be a disk drive array. The number of storage devices 600 in storage array 601 may vary. Storage system 508 also includes array controller 605 connected to each storage device 600 in storage array 601 via one or more data paths. Data paths may provide communication between array controller 605 and storage devices 600 using various communication protocols, as described with respect to FIG. 1.

The removable configuration module 650 may store configuration data for the component 600g. The configuration data may be used to configure the component 600g for use by a host via a network. For example, the configuration data may include various system parameters needed to configure the component 600g once component 600g is installed. The system parameters may include unique component identifiers, logical and physical layout data, component status indicators, or other parameters needed by the host in order to utilize the component. For example, the host may access the array controller, and logical and physical layout data for the array controller may include logical unit numbers (LUN) and mirror identifiers (e.g., identifiers for each redundant storage device 600). Note that even though a single component shown includes a removable configuration module, more than one component may include a removable storage module. For example, each of the storage devices 600 may be coupled to a removable configuration module 650 that stores configuration data for that storage device. In one embodiment, a world wide name (WWN) and media access control (MAC) address may be created from the midplane 602 serial number of the storage system 508 and stored on the removable configuration module 650. The removable configuration module 650 may store logical and physical layout data for the storage device array 601. The configuration data may be accessed by the array controller 605 to obtain the WWN and MAC address for a particular storage device 600 in the storage device array 601. The WWN may be used, for example, to create a reference (e.g., path or link) to the particular storage device 600. This reference may be a node or host identifier to access the particular storage device 600 via the network.

Some configuration data may be specific to each type of component. Other configuration data may be specific to each component. For example, logical and physical layout data may be specific to a group of components. A unique component identifier may be specific to a particular component within the group. Even though logical and physical layout data may be the same for a group of components, each component of the group may still be coupled to its own removable configuration module 650 in some embodiments.

Although other components illustrated in FIG. 2 are not shown coupled to a removable configuration module, in other embodiments, one or more components may be coupled to respective removable storage media. For example, the array controller 605 may be coupled to a removable configuration module 650. The fabric device 508 may also include power/cooling unit 603 and loopcard 604. The power/cooling unit 603 may be used to power the storage devices 600, and may include a power supply, cooling fans and an integrated battery backup. The loopcard 604 may be used to interconnect multiple storage device arrays. Thus, depending on configuration data needs, and on suitability of a removable configuration module for a type of component, other components may be coupled to a removable configuration module.

A component interface, such as array controller 605, may access the configuration data stored on the removable configuration module 650. The component interface may be software, hardware or combinations thereof. The component interface may be configured to access the configuration data from the removable configuration module 650, or may be configured to access a component which accesses the removable configuration module 650 (e.g., the component to which the removable configuration module is coupled).

In one embodiment, the component interface may be software program instructions configured to read the configuration data for the component 600g from the removable configuration module 650. For example, the component interface may be a component manager application executed by an operating system to manage and configure the component 600g. The component interface may access another set of software program instructions configured to read the configuration data from the removable configuration module 650. In other embodiments, the component interface may be a network driver called by an operating system library interface to manage and configure the component 600g. In further embodiments, a mechanism used to manage and configure the component 600g may be executed from a command line interface of an operating system. Conversely, the component interface may be configured to primarily read the configuration data from the removable configuration module 650. The component 600g and/or the component interface may be external to a host, although accessible to the host.

The component interface may be executed when the host configures the component 600g for use by the host. For example, the component interface may be configured to obtain and provide a unique identifier for the component 600g to the host via a network. A unique identifier for the component 600g may be stored on the removable configuration module 650 instead of or in addition to being stored in the component's programmable read only memory (PROM). Applications running on the host may call the component interface to read the identifier from the removable configuration module 650 and then manipulate the identifier to generate a host identifier for the component 600g. Based on this host identifier, the component 600g may be accessed from the host.

The removable configuration module 650 may be removed and coupled to another component of the same type. The same configuration data stored on the removable configuration module 650 may be associated with a different component by transferring the removable configuration module to the different component. After installation of the different component, the different component may be associated with the same configuration data. In embodiments where the different component replaces an old component, the new (different) component may appear to the system to be the same old component from which the removable configuration module 650 was removed since the new component is configured with the same configuration information from the removable configuration module 650. For example, the different component may readily accessible by the host via the network just like the component it replaced. A reference (e.g., path or link) to the different component may not need to be recreated.

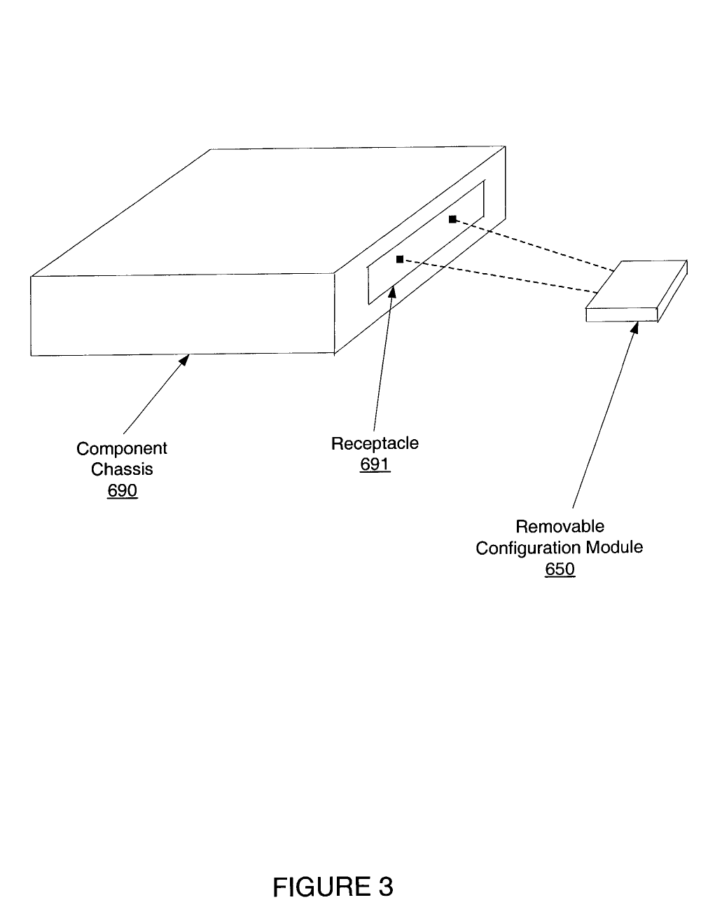

FIG. 3 shows a component chassis 690 coupled to a receptacle 691. The removable configuration module 650 may be inserted into receptacle 691. Insertion may involve connecting the removable configuration module 650 to a receptacle 691 in order to access the configuration data stored on module 650. The removable configuration module 650 could also plug into or snap onto connectors on or accessible from the outer surface of component chassis 690. The component chassis 690 may be a physical frame or structure that encloses component 600g. Component chassis 690 may enclose a front logic card, rear interface card and other electrical devices included in component 600g. Depending on the type of component, component 600g may also include other physical and/or mechanical parts such as platters, a spindle, read/write heads, etc.

The removable configuration module 650 may include a non-volatile memory medium such as flash memory. The removable configuration module 650 may be a card such as a smart card, compact flash card, or other card (with at least one memory chip or other storage device for configuration data) that may be removed and replaced with another suitable card for use with a component. For example, removable configuration module 650 may be a card similar to a plastic credit card and may include at least one memory chip.

The removable configuration module 650 may be a compact memory device that does not have to be removed and sent back to a manufacturer to be reprogrammed. Examples of compact memory devices are flash memory cards used in digital audio devices (e.g., MP3) and digital cameras. The compact memory device may be smaller than these examples for embodiments where a small amount of configuration data is stored. Memory on a compact memory device may be erased by exposing the memory to an electrical charge. Configuration data associated with a component may be written to a compact memory device. The removable configuration module 650 may retain the configuration data even when power is turned off (i.e., may be a non-volatile memory). Also, the configuration information stored on the removable configuration module 650 may be updated if necessary.

Receptacle 691 may be configured to allow insertion of a removable configuration module. In one embodiment, receptacle 691 may be a reader or other device for accessing the configuration data from the removable configuration module 650. In some embodiments, receptacle 691 may read configuration data from the removable configuration module 650 and provide the configuration data to a mechanism (e.g., a component interface and/or the component's firmware) in order to configure the component (e.g., for access by a host).

Receptacle 691 may include a connector configured to be coupled to a connector included in a removable configuration module 650. For example, receptacle 691 may include a male-type pin connector and removable configuration module 650 may include a female-type pin connector. In other embodiments, a receptacle 691 may be configured to receive a signal from a removable configuration module 650 without using a physical connector to a component. For example, in one embodiment, signals from a removable configuration module 650 may be transmitted to a receptacle 691 configured to receive signals (e.g., radio frequency, infrared, etc) over a wireless link.

The removable configuration module 650 may be removed and coupled to another receptacle 691 of the same type. In some embodiments, the removable configuration module 650 may not remain coupled to a component in order to configure the component. For example, a removable configuration module 650 may be coupled to a component, configuration data may be read from the removable configuration module 650 and stored in another location (e.g., on the component), the removable configuration module 650 may be removed, and then the component may be configured using the stored configuration data. Thus, by coupling and decoupling the removable configuration module 650 to individual components, identical configuration data may be associated with multiple components.

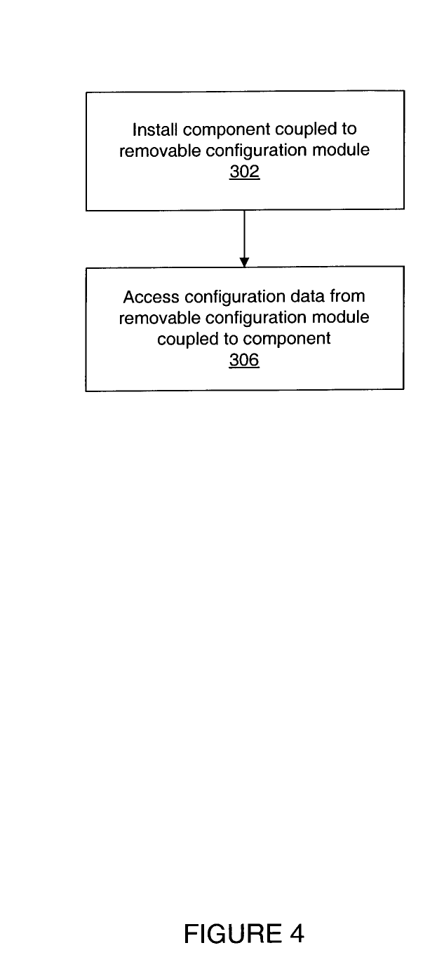

FIG. 4 shows one embodiment of a method for accessing configuration data stored on a removable configuration module coupled to a component. The removable configuration module may store configuration data for the component. In one embodiment, the removable configuration module may be a smart card and may store a status indicator for the component. For example, when the component is configured, the component may be assigned a master or slave status and the status indicator may indicate the assigned status.

The component may be installed, as indicated in 302, and the component may be configured to be accessible by a host computer system. For example, after the component is properly installed, the host computer system may access the configuration data stored on the removable configuration module, as indicated in 306. In one embodiment, a component interface configured to access the removable configuration module may read the configuration data and provide the configuration data to the host computer system. The host computer system may use the configuration data to configure the component for use by the host computer system. The removable configuration module may provide the configuration data to the component interface when the host computer system is configuring the component.

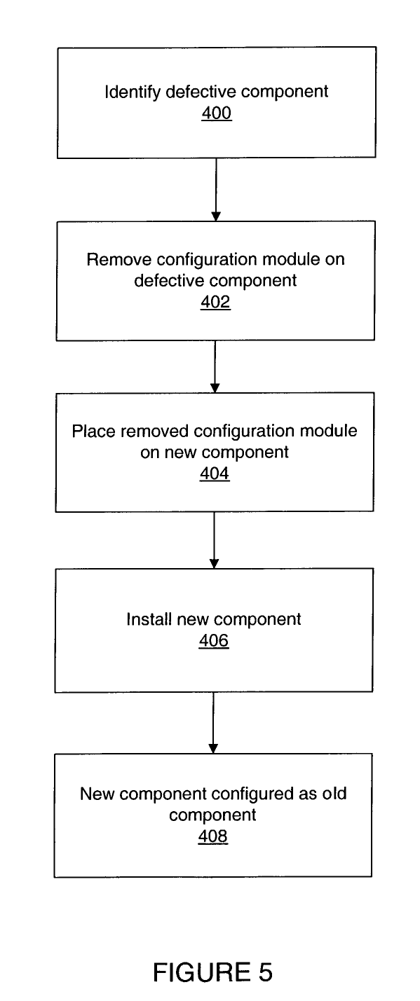

FIG. 5 shows another embodiment of a method for accessing configuration data stored on a removable configuration module coupled to a component. A component may be operating in a computer system environment and may be identified as defective, as indicated in 400. The component may be identified as defective by an operating system, a user, or another mechanism (e.g., a self test performed by the component). Since the computer system relies on the component, a user may wish to uninstall the component and replace the component with a new component. The removable configuration module coupled to the defective component may store configuration data for the component. For example, the computer system may recognize or identify the component based on a unique identifier stored on the removable configuration module. The user may remove the removable configuration module from the defective component, as indicated in 402, and place the removable configuration module on the new component, as indicated in 404. The user may then install the new component, which is coupled to the removable configuration module, as indicated in 406. The new component may be readily accessible by the computer system. For example, after the component is properly installed, the new component may be used just like the defective component, as indicated in 408. In one embodiment, to the computer system, it may appear as if the defective component started operating again. The new component may be readily accessible without having to recreate a reference (e.g., path or link) from the computer system to the new component. In one embodiment, a component interface (e.g., a network driver called by an operating system library interface) may continue to read the configuration data from the removable configuration module. In other embodiments, the new component and/or the component interface may be external to the computer system, although accessible to the computer system.

In one embodiment, a component interface configured to access the removable configuration module may access the configuration data and provide the configuration data to an application running on the computer system.

Referring again to FIG. 1, in different embodiments, hosts 502 may take various forms, including a personal computer system, desktop computer, notebook computer, workstation, server, mainframe computer system, network appliance, network computer, Internet appliance, personal digital assistant (PDA), embedded device, smart phone, television system, another suitable device, or combinations thereof. In general, the term computer system may be broadly defined to encompass any device having a processor which executes instructions from a computer accessible medium such as memory 107. Hosts 502 may be attached to a network as part of a distributed computing environment.

Note that the flow charts described herein represent exemplary embodiments of methods. The methods may be implemented in software, hardware, or a combination thereof. The order of method may be changed, and various elements may be added, reordered, combined, omitted, modified, etc. For example in FIG. 5, a new component may be installed (406) before, after or during placement of a removable configuration module on the new component (404).

Various modifications and changes may be made as would be obvious to a person skilled in the art having the benefit of this disclosure. Note also that the flow charts described herein do not necessary require a temporal order. It is intended that the following claims be interpreted to embrace all such modifications and changes and, accordingly, the specifications and drawings are to be regarded in an illustrative rather than a restrictive sense.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

What is claimed is:

1. A system, comprising:
a network;
a first component coupled to the network;
a removable configuration module coupled to the first component, wherein the removable configuration module comprises configuration data for configuring the first component for access via the network, wherein the removable configuration module is configured to be decoupled from the first component and coupled to a second component in order to configure the second component for access via the network using the configuration data; and
wherein the configuration data includes a unique component identifier.

2. The system as recited in claim 1, wherein the unique component identifier is at least one of a World Wide Name (WWN) and a media access control (MAC) address.

3. The system as recited in claim 1, wherein the removable configuration module is a card including at least one memory device.

4. The system as recited in claim 3, wherein the card is a compact flash card or a smart card.

5. The system as recited in claim 1, further including a component interface configured to access the configuration data from the removable configuration module and to provide the configuration data to an application executing on the system, wherein the application is configured to configure the first component for access via the network.

6. The system as recited in claim 5, wherein the application receives the configuration data and creates a unique system identifier for accessing the first component via the network.

7. The system as recited in claim 1, wherein the network comprises a Fibre Channel switched fabric comprising a plurality of Fibre Channel switches.

8. The system as recited in claim 1, wherein the network is part of a storage area network (SAN), wherein the first component comprises a storage device.

9. The system as recited in claim 1, wherein the configuration data further comprises at least one of: logical layout data, physical layout data and a component status indicator.

10. The system as recited in claim 1, wherein the first component is a field replaceable unit (FRU).

11. A method, comprising:
accessing a removable configuration module coupled to a first component, wherein the removable configuration module comprises configuration data for configuring the first component for access via a network, wherein the configuration data includes a unique component identifier;
decoupling the removable configuration module from the first component and coupling the removable configuration module to a second component;
accessing the removable configuration module coupled to the second component in order to configure the second component for access via the network using the configuration data.

12. The method as recited in claim 11, wherein the removable configuration module is a card including at least one memory device.

13. The method as recited in claim 12, wherein the card is a compact flash card or a smart card.

14. The method as recited in claim 11, further comprising a component interface accessing the configuration data from the removable configuration module and providing the configuration data to an application executing on the system, wherein the application is configured to configure the first component for access via the network.

15. The method as recited in claim 14, further comprising the application receiving the configuration data and creating a unique system identifier to access the first component via the network.

16. The method as recited in claim 11, wherein the network comprises a Fibre Channel switched fabric comprising a plurality of Fibre Channel switches.

17. The method as recited in claim 11, wherein the network is part of a storage area network (SAN), wherein the first component and the second component comprise storage devices.

18. The method as recited in claim 11, wherein the second component is configured to be accessible as if it were the first component.

19. A component, comprising:
a component chassis;
a receptacle coupled to the component chassis, wherein the receptacle is configured to access configuration data stored on a removable configuration module;
wherein the configuration data includes a unique component identifier.

20. The component as recited in claim 19, wherein receptacle is configured to have at least a portion of the removable configuration module inserted into the receptacle.

21. The component as recited in claim 19, wherein the receptacle is a smart card reader.

22. The component as recited in claim 19, wherein the receptacle is a compact flash card reader.
